(19) United States
(12) Patent Application Publication
(10) Pub. No.: US 2026/0266311 A1
(43) Pub. Date: Sep. 10, 2026

(54) CENTRIFUGAL COMPRESSOR

(71) Applicant: DAIKIN INDUSTRIES, LTD., Osaka (JP)

(72) Inventors: Yuki KAWACHIYA, Osaka (JP); Kosuke NISHIMURA, Osaka (JP); Koichi TANAKA, Osaka (JP); Arihiro IWATA, Osaka (JP); Daigo FUKUDA, Osaka (JP)

(21) Appl. No.: 19/166,234

(22) PCT Filed: Mar. 29, 2024
(86) PCT No.: PCT/JP2024/013113

§ 371 Date: Sep. 17, 2025

(30) Foreign Application Priority Data
Mar. 31, 2023 (JP) 2023-058713

(51) Int. Cl. F04D 29/42; F04D 17/12; F04D 29/058; F04D 29/28

(52) U.S. Cl. CPC F04D 29/4226; F04D 17/122; F04D 29/058; F04D 29/284

(57) ABSTRACT

Leakage flow in a gap between the tip of a blade and a casing is reduced.

A centrifugal compressor includes an open-type impeller having a hub and blades provided on a periphery of the hub; a drive shaft connected to the impeller; a bearing for supporting the drive shaft; and a casing for covering the impeller, wherein a movable range in a radial direction of the drive shaft with respect to the bearing is larger than a movable range in an axial direction of the drive shaft with respect to the bearing, and a first gap between an outer peripheral edge of the blade on a gas inlet side and an inner wall of the casing is larger than a second gap between an outer peripheral edge of the blade on a gas outlet side and the inner wall of the casing.

### TECHNICAL FIELD

The present disclosure relates to a centrifugal compressor.

### BACKGROUND ART

For example, a refrigerator applied to an air conditioner includes a compressor, a condenser, an expansion valve, and an evaporator. Patent Document 1 discloses a centrifugal compressor as a compressor. The centrifugal compressor described in Patent Document 1 includes a rotor having a hub and blades, and a casing surrounding the rotor.

### CITATION LIST

### Patent Document

[Patent document 1] WO 2018/146752

### SUMMARY OF INVENTION

### Technical Problem

When a centrifugal compressor is operated, a leakage flow occurs in which gas flows from a high pressure side to a low pressure side through a gap between a blade tip and a casing. This leakage flow lowers the operating efficiency of the centrifugal compressor. An object of the present disclosure is to provide a centrifugal compressor capable of reducing a leakage flow in a gap between a blade tip and a casing.

### Solution to Problem

A centrifugal compressor according to one embodiment of the present disclosure includes:
an open-type impeller having a hub and blades provided on a periphery of the hub;
a rotating shaft connected to the impeller;
a bearing for supporting the rotating shaft; and
a casing for covering the impeller, wherein
a movable range in a radial direction of the rotating shaft with respect to the bearing is larger than a movable range in an axial direction of the rotating shaft with respect to the bearing, and
a first gap between an outer peripheral edge of the blade on a gas inlet side and an inner wall of the casing is larger than a second gap between an outer peripheral edge of the blade on a gas outlet side and the inner wall of the casing.

In the centrifugal compressor according to the present embodiment, the second gap between the outer periphery edge of the blade on the gas outlet side and the inner wall of the casing is narrower than the first gap between the outer periphery edge of the blade on the gas inlet side and the inner wall of the casing. In this centrifugal compressor, a second gap narrower than the first gap on the inlet side where the pressure is lower, is formed on the outlet side where the pressure is higher in the gas flow direction. Thus, the leakage flow in the gap between the outer periphery edge of the blade and the casing can be reduced on the outlet side where the pressure is higher.

In the centrifugal compressor according to one embodiment of the present disclosure, a minimum point of a blade angle of the blade is located in a latter half of the blade.

Tn the centrifugal compressor of the present embodiment, the blade load is high at the position where the blade angle becomes the minimum point. In the part where the blade load is high, the pressure difference between the positive pressure surface and the negative pressure surface of the blade becomes large. In the centrifugal compressor of the present embodiment, the pressure difference between the positive pressure surface and the negative pressure surface of the blade becomes large at the latter half of the blade.

In the centrifugal compressor according to one embodiment of the present disclosure, the minimum point of the blade angle is located at a position of 0.6 m or more and 1.0 m or less with respect to a meridional length m.

Note that the meridional length is defined on the meridional plane (shapes of the blade shape being rotated and projected around the rotational axis are superimposed, in a cross section along the rotational axis).

In the centrifugal compressor according to one embodiment of the present disclosure,
a direction that is along the blade and that is in a direction perpendicular to a direction of the meridional length m, is given as a span direction; and
when a length from an outer peripheral surface of the hub to an outer peripheral edge of the blade in the span direction is given as a span length s,
at a position of 0.5 s or more with respect to the span length s, the minimum point of the blade angle may be located at the latter half of the blade.

In the centrifugal compressor according to one embodiment of the present disclosure, at a position of 0.9 s or more with respect to the span length s, the minimum point of the blade angle may be located at the latter half of the blade.

In the centrifugal compressor according to one embodiment of the present disclosure, the bearing may be an air bearing, a foil bearing, an active magnetic bearing, a rolling bearing, or a sliding bearing.

In the centrifugal compressor according to one embodiment of the present disclosure,
the bearing is the active magnetic bearing, and
the active magnetic bearing can control a position of the rotating shaft such that a distance to a touchdown in the radial direction of the rotating shaft is greater than a distance to a touchdown in the axial direction of the rotating shaft.

In the centrifugal compressor according to one embodiment of the present disclosure, a distance of the first gap may be twice or more than a distance of the second gap.

In the centrifugal compressor according to one embodiment of the present disclosure, a rotational speed of the impeller may be 30,000 rpm or more.

### BRIEF DESCRIPTION OF DRAWINGS

FIG. 1 is a schematic diagram illustrating a refrigerator equipped with a centrifugal compressor according to an embodiment.

FIG. 2 is a schematic diagram illustrating a centrifugal compressor according to an embodiment.

FIG. 3 is a side view of an impeller.

FIG. 4 is a longitudinal cross-sectional view illustrating the gap between the outer peripheral edge of the impeller and the inner wall of the casing.

FIG. 5 is a graph illustrating the relationship between meridional length and blade angle.

FIG. 6 is a diagram illustrating the outer peripheral edge of the impeller and meridional length.

FIG. 7 is a graph illustrating the relationship between the meridional length and the static pressure coefficient.

FIG. 8 is a graph illustrating the relationship between meridional length and static pressure.

FIG. 9 is a schematic diagram illustrating a centrifugal compressor according to an embodiment.

FIG. 10 is a diagram in which shapes of the blade shape being rotated and projected around the rotational axis C1 are superimposed, in a cross section along the rotational axis C1.

### DESCRIPTION OF EMBODIMENTS

Non-limiting embodiments of the present invention will be described with reference to the accompanying drawings. In the accompanying drawings, the same or corresponding members or parts are assigned the same or corresponding reference numerals. In the following description, duplicate descriptions of the same or corresponding members or parts are omitted. In the drawings, the members or parts are not necessarily drawn to scale. Therefore, a person skilled in the art has freedom to determine the specific dimensions by referring to the following non-limiting examples. Further, the following examples are illustrative rather than limiting the present invention. Further, the features and combinations described in the examples are not necessarily essential to the present invention.

### [Outline of Refrigerator According to an Embodiment]

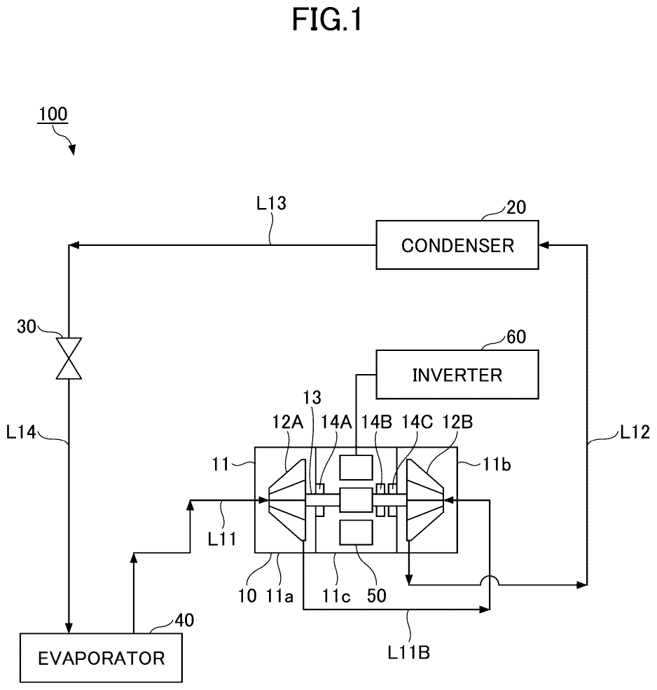

Referring to FIG. 1, a refrigerator 100 equipped with a centrifugal compressor according to an embodiment will be described. The refrigerator 100 illustrated in FIG. 1 is used, for example, for air conditioning equipment, freezing equipment, and refrigeration equipment. The refrigerator 100 may be used for other equipment. The refrigerator 100 performs a refrigeration cycle. A refrigeration cycle of the refrigerator 100 is a vapor compression refrigeration cycle. The refrigerator 100 includes a centrifugal compressor 10, a condenser 20, an expansion valve 30, and an evaporator 40. The centrifugal compressor 10 is a turbo compressor.

A refrigerant which is the working fluid of the refrigerator 100 is not particularly limited. The centrifugal compressor 10 compresses the refrigerant gas. The condenser 20 condenses the refrigerant gas compressed by the centrifugal compressor 10. The expansion valve 30 expands the refrigerant condensed by the condenser 20. The evaporator 40 evaporates the refrigerant expanded by the expansion valve 30. The refrigerant gas evaporated by the evaporator 40 is sucked into the centrifugal compressor 10.

The centrifugal compressor 10 performs reversible adiabatic compression of the refrigerant gas. The refrigerant gas supplied to the condenser 20 releases heat at a constant pressure and liquifies. The liquefied refrigerant is irreversibly expanded at a constant enthalpy by the expansion valve 30, and a part of the refrigerant is evaporated. The refrigerant absorbs heat at a constant pressure in the evaporator 40.

The refrigerator 100 includes pipes L11 to L14 through which the refrigerant flows. The pipe L11 is a suction pipe connecting the evaporator 40 and the centrifugal compressor 10. The pipe L12 connects the centrifugal compressor 10 and the condenser 20. The pipe L13 connects the condenser 20 and the expansion valve 30. The pipe L14 connects the expansion valve 30 and the evaporator 40.

The refrigerant gas flows through the pipe L11 and is sucked into the centrifugal compressor 10. The refrigerant gas compressed by the centrifugal compressor 10 flows through the pipe L12 and is supplied to the condenser 20. The refrigerant liquid liquefied in the condenser 20 flows through the pipe L13 and flows into the expansion valve 30. The refrigerant expanded in the expansion valve 30 flows through the pipe L14 and is supplied to the evaporator 40. The refrigerant gas that has absorbed heat at the evaporator 40 flows through the pipe L11 and is supplied to the centrifugal compressor 10.

### [Centrifugal Compressor]

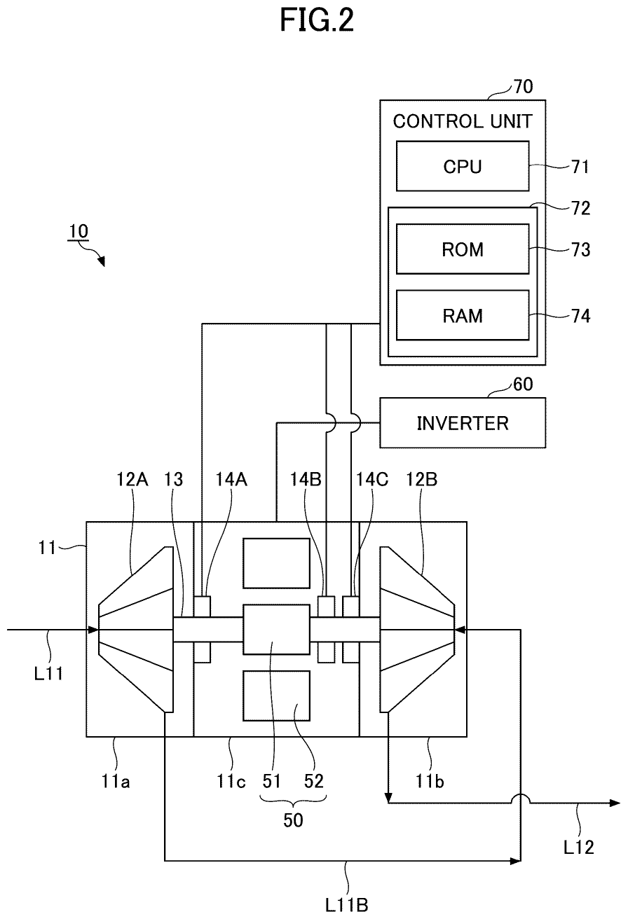

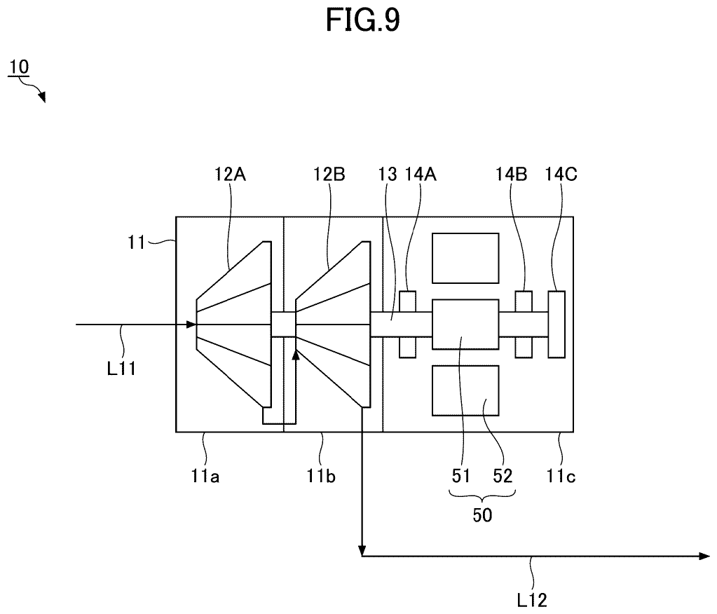

Next, the centrifugal compressor 10 will be described. The centrifugal compressor 10 is, for example, a two-stage compressor. The centrifugal compressor 10 may be a single-stage compressor. As illustrated in FIG. 2, the centrifugal compressor 10 includes a casing 11, impellers 12A and 12B, a drive shaft 13, bearings 14A and 14B, and a motor 50. The casing 11 accommodates impellers 12A and 12B, a drive shaft 13, bearings 14A and 14B, and a motor 50. The centrifugal compressor 10 has a back-to-back structure in which the backsides of the impellers 12A and 12B face each other. As illustrated in FIG. 9, the centrifugal compressor 10 may have an in-line structure in which the impellers 12A and 12B are connected in the same direction.

The casing 11 has a compression chamber 11a containing the impeller 12A, a compression chamber 11b containing the impeller 12B, and a motor chamber 11c containing the motor 50. The centrifugal compressor 10 includes a pipe L11B connecting the compression chamber 11a and the compression chamber 11b. The pipe L11B is a pipe for supplying the refrigerant gas discharged from the low-pressure compression chamber 11a to the high-pressure compression chamber 11b.

### [Drive Shaft]

The impellers 12A and 12B are provided at both ends of the drive shaft 13. The impeller 12A is provided at one end of the drive shaft 13, and the impeller 12B is provided at the other end of the drive shaft 13. The impellers 12A and 12B are arranged apart in the axial direction of the drive shaft 13. The drive shaft 13 includes a rotating shaft of the motor 50. The rotating shaft of the motor 50 includes a portion between the impeller 12A and the impeller 12B in the drive shaft 13.

### [Bearing]

The bearings 14A and 14B rotatably support the drive shaft 13. The bearings 14A and 14B are fixed to the casing 11. The bearings 14A, 14B, and 14C are radial bearings and thrust bearings. The centrifugal compressor 10 includes a plurality of bearings 14A, 14B, and 14C. The bearings 14A, 14B, and 14C are oilless bearings, for example. The bearings 14A and 14B may be sliding bearings or rolling bearings. The bearings 14A, 14B, and 14C may be static pressure bearings. Oilless bearings do not require the supply of lubricating oil. Examples of oilless bearings include gas bearings, air bearings, foil bearings, and magnetic bearings.

The bearings 14A, 14B, and 14C may be air bearings. The air bearings are a kind of static pressure bearings, and can support the load by blowing compressed air between the drive shaft 13 and the bearing surface to float the drive shaft 13 by air pressure. The bearings 14A and 14B may be gas bearings that float the drive shaft 13 by blowing compressed gas between the drive shaft 13 and the bearing surface. The gas bearings may be those that float the drive shaft 13 by blowing refrigerant gas as compressed gas.

The bearings 14A, 14B, and 14C may be foil bearings which are a kind of pneumatic dynamic pressure bearings. The foil bearing has a thin film (foil) as a bearing surface. The thin film has low rigidity against bending, and has flexibility. The foil bearing supports the load by allowing the deflection of the foil. When the drive shaft 13 rotates, a fluid film (air film) is formed between the drive shaft 13 and the bearing surface which is the foil. The foil bearing supports the drive shaft 13 by using the foil and the fluid film. The foil bearing can form a bearing gap depending on the rotational speed of the drive shaft 13, the load of the drive shaft 13, the ambient temperature of the drive shaft 13, and other operating conditions due to the flexibility of the foil.

The bearings 14A, 14B, and 14C may be magnetic bearings supporting the rotating shaft by utilizing magnetic attraction or repulsion. The bearings 14A, 14B, and 14C may be active magnetic bearings (AMB). In the active magnetic bearing, for example, the bearings 14A and 14B may be radial magnetic bearings and the bearing 14C may be a thrust magnetic bearing. The radial magnetic bearing includes an electromagnet arranged around the drive shaft 13. The electromagnet has an iron core and a coil. The thrust magnetic bearing includes an axial disk projecting radially outward from the drive shaft 13 and an electromagnet arranged so as to face the axial disk in the axial direction.

The types, positions, and quantities of the bearings 14A, 14B, and 14C are not limited to those described above. The centrifugal compressor 10 may include a touchdown bearing. The touchdown bearing is also referred to as an auxiliary bearing or a backup bearing. The touchdown bearing limits the movable range of the drive shaft 13. The touchdown bearing limits the movable range of the drive shaft 13 in the radial direction. The touchdown bearing can limit the movable range of the drive shaft 13 in the axial direction. The touchdown bearing can prevent the stator from contacting the rotor. The touchdown bearing can support the drive shaft 13 when the magnetic bearing is not energized.

The active magnetic bearing can control the position of the drive shaft 13 so that the distance to the touchdown in the radial direction of the drive shaft 13 is greater than the distance to the touchdown in the axial direction of the drive shaft 13. The distance to the touchdown may be the distance until the drive shaft 13 contacts the touchdown bearing. The distance to the touchdown may be the movable range of the drive shaft 13. The distance to the touchdown may be the maximum movable range of the drive shaft 13.

The centrifugal compressor 10 may include a control unit 70 capable of controlling the movable range of the drive shaft 13. The control unit 70 can control the current supplied to the Coils of the bearings 14A, 14B, and 14C, which are active magnetic bearings. The control unit 70 can control the movable range in the radial direction and the movable range in the axial direction of the drive shaft 13 by controlling the current supplied to the coils. The control unit 70 can control the position of the drive shaft 13 so that the movable range in the radial direction of the drive shaft 13 is larger than the movable range in the axial direction of the drive shaft 13.

### [Motor]

The motor 50 is a driving source of the centrifugal compressor 10. The motor 50 has a rotor 51 and a stator 52. The rotor 51 is fixed to the drive shaft 13 and rotates with the drive shaft 13. The stator 52 is fixed to the casing 11 and is arranged around the rotor 51.

The refrigerator 100 includes an inverter 60. The inverter 60 controls the rotational speed of the motor 50. The inverter 60 is a controller that controls the operating frequency of the motor 50. The rotational speed of the impellers 12A and 12B and the drive shaft 13 may be 30,000 rpm or more. The inverter 60 can change the rotational speed of the impellers 12A and 12B and the drive shaft 13 by controlling the operating frequency of the motor 50.

The impellers 12A and 12B of the centrifugal compressor 10 rotate by receiving the rotational driving force of the motor 50. By rotating the impellers 12A and 12B, refrigerant gas is compressed. The impeller 12A is a low-pressure side impeller, and the impeller 12B is a high-pressure side impeller. The refrigerant gas compressed by the impeller 12A is supplied to the impeller 12B. The impeller 12B further compresses the refrigerant gas discharged from the impeller 12A.

### [Control Unit]

The control unit 70 includes a CPU 71 and a storage unit 72. The CPU (Central Processing Unit) 71 controls the overall processing in the refrigerator 100. The CPU 71 can control the rotational speed of the motor 50 via the inverter 60. The CPU 71 can control the opening and closing operation of the expansion valve 30.

The storage unit 72 includes a ROM (Read Only Memory) 73 and a RAM (Random Access Memory) 74. The ROM 73 stores various programs for making the CPU 71 execute control processing and various kinds of data necessary for the operation of the refrigerator 100. The RAM 74 can temporarily store data and the like acquired from various sensors.

### [Impeller]

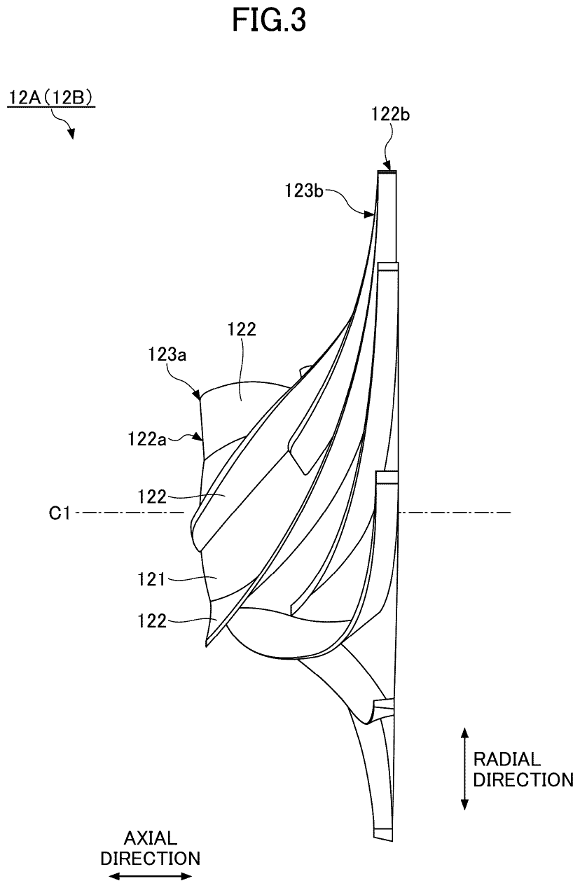

Next, the impeller 12A will be described. As illustrated in FIG. 3, the impeller 12A has and a hub 121 and a blade 122 provided on the outer periphery of the hub 121. The hub 121 is connected to the end of the drive shaft 13.

The hub 121 has a substantially conical shape whose diameter expands from the front to the rear. The hub 121 rotates integrally with the drive shaft 13. The inside of the hub 121 may be hollow except for the peripheral part of the shaft and the outer peripheral edge part from the viewpoint of weight reduction.

The blades 122 project radially outward from the outer peripheral surface of the hub 121. The blades 122 are arranged spirally along the outer peripheral surface of the hub 121. The impeller 12B is the same as the impeller 12A, and a description thereof will be omitted.

### [Movable Range of the Drive Shaft]

Next, the movable range of the drive shaft 13 will be described. In the centrifugal compressor 10, the movable range of the drive shaft 13 in the radial direction is larger than the movable range of the drive shaft 13 in the axial direction. The movable range of the drive shaft 13 in the radial direction with respect to the bearings 14A, 14B, and 14C is larger than the movable range of the drive shaft 13 in the axial direction with respect to the bearings 14A, 14B, and 14C. For example, the movable range of the drive shaft 13 may be the actual movable range of the drive shaft 13 or the movable range of the impellers 12A and 12B connected to the drive shaft 13. The movable range of the drive shaft 13 may be the movable range of the rotor 51 fixed to the drive shaft 13. The movable range of the drive shaft 13 may be the movable range of any one position or the average value of a plurality of positions.

### [Gap Between Impeller Blades and Inner Wall of Casing]

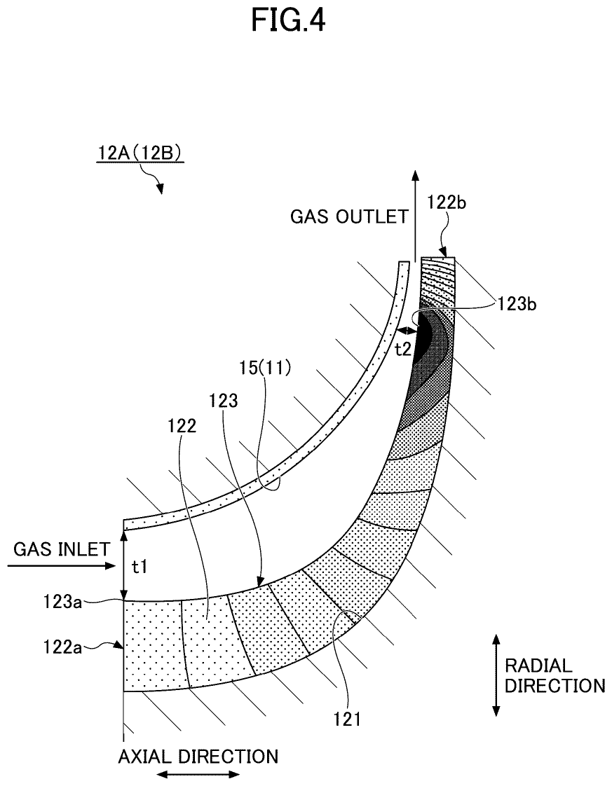

Next, the gap between the blades 122 of the impellers 12A and 12B and the inner wall 15 of the casing 11 will be described with reference to FIG. 4. FIG. 4 is a longitudinal sectional view illustrating the gap between the outer peripheral edges 123 of the impellers 12A and 12B and the inner wall 15 of the casing 11, and includes meridional sections of the impellers 12A and 12B.

The blade tip gap t1 between the gas inlet side outer peripheral edge 123a of the blade 122 and the inner wall 15 of the casing 11 is larger than the blade tip gap t2 between the gas outlet side outer peripheral edge 123b of the blade 122 and the inner wall 15 of the casing 11. The blade tip gap t1 is an example of the first gap. The blade tip gap t2 is an example of the second gap.

The outer peripheral edges 123a and 123b are the tips of the blades 122. The outer peripheral edges 123a and 123b are away from the outer peripheral surface of the hub 121 in the radial direction of the impellers 12A and 12B. The outer peripheral edges 123a and 123b are the ends of the impellers 12A and 12B in the radial direction.

The gas inlet side is the small-diameter side of the hub 121, and the gas outlet side is the large-diameter side of the hub 121. The small-diameter side of the hub 121 is far from the motor 50 in the axial direction of the drive shaft 13, and the large-diameter side of the hub 121 is close to the motor 50 in the axial direction of the drive shaft 13.

The blade tip gap t1 on the gas inlet side may be at least twice as large as the blade tip gap t2 on the gas outlet side. The blade tip gap t1 on the gas inlet side may be a blade tip gap at a position of the leading edge 122a close to the gas inlet, or a blade tip gap at a position behind the leading edge 122a in the axial direction. The blade tip gap t1 may be a position where the blade tip gap becomes maximum. The blade tip gap may be a distance between a curve representing the shape of the outer peripheral edge 123 and a curve representing the shape of the inner wall 15 of the casing 11 on the axially cut surfaces of the impellers 12A and 12B. For example, the blade tip gap may be a length along a normal line with respect to the curve representing the shape of the outer peripheral edge 123.

The blade tip gap t2 on the gas outlet side may be a blade tip gap at a position of the trailing edge 122b close to the gas outlet, or a blade tip gap at a position in front of the trailing edge 122b in the axial direction. The blade tip gap t2 on the gas outlet side may be a position where the blade tip gap is minimized. The blade tip gap t2 on the gas outlet side may be a blade tip gap at a position of 0.5 m or more and 1.0 m or less with respect to the meridional length m described later. Note that 0.5 m and 1.0 m mean lengths 0.5 and 1.0 times the meridional length m, respectively. The blade tip gap t2 may be a blade tip gap at a position of 0.6 m or more and 1.0 m or less with respect to the meridional length m, or a blade tip gap at a position of 0.75 m or more and 0.95 m or less. The blade tip gap t2 may be a blade tip gap at a position of, for example, 0.8 m with respect to the meridional length m, or a blade tip gap at a position of, for example, 0.9 m with respect to the meridional length m.

### [Relationship Between Meridional Length and Blade Angle]

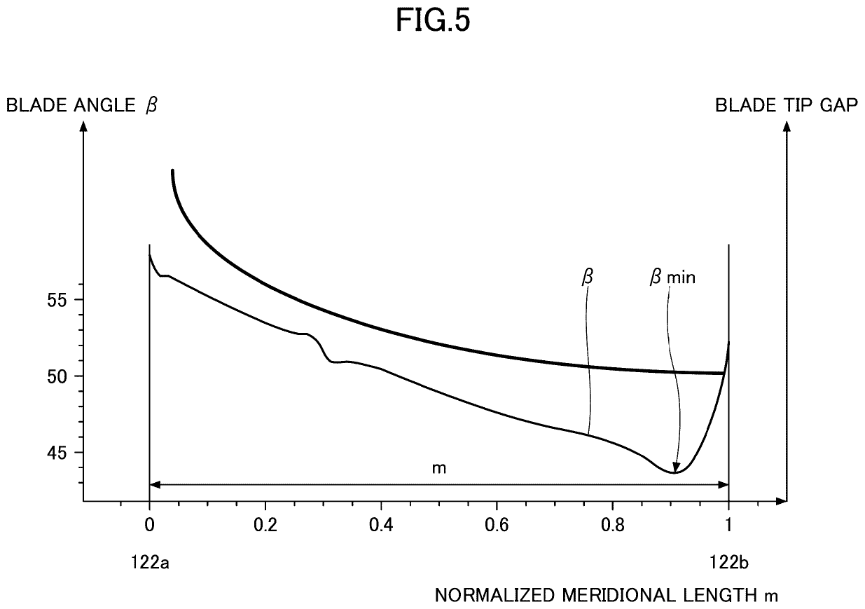

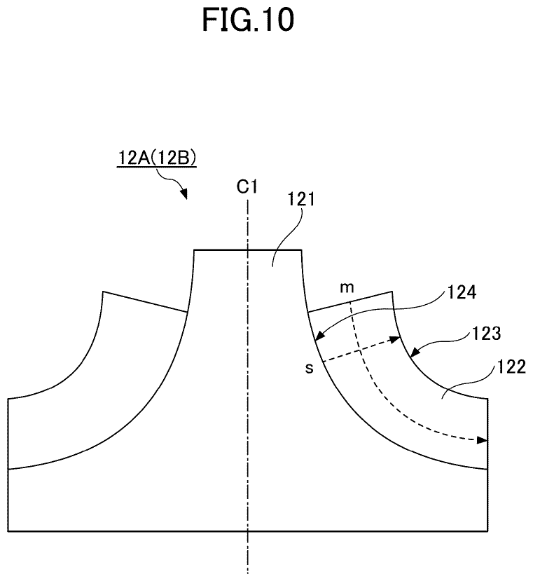

Next, the relationship between meridional length and blade angle will be described. FIG. 5 is a graph illustrating the relationship between meridional length and blade angle. In FIG. 5, the normalized meridional length is indicated on the horizontal axis, and the blade angle is indicated on the vertical axis. The “meridional length” is the length defined on the meridional plane (see FIG. 10, a diagram in which shapes of the blade shape being rotated and projected around the rotational axis C1 are superimposed, in a cross section along the rotational axis C1). The rotational axis C1 is the rotational axis of the drive shaft 13 and the rotational axis of the impellers 12A and 12B. The blade shape is the shape along the outer peripheral edge of the blade 122.

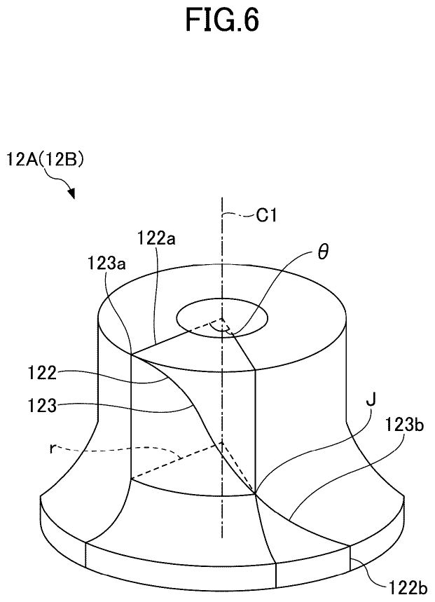

The horizontal axis illustrated in FIG. 5 indicates the ratio (normalized value) of the meridional length when the total length is “m”. The notation of “0” is the length corresponding to 0 times the meridional length m at the end of the gas inlet side and the position of the leading edge 122a of the blade 122, and the notation of “1” is the length corresponding to 1 times the meridional length m at the end of the gas outlet side and the position of the trailing edge 122b of the blade 122. The same applies to FIGS. 6 to 9 below.

The minimum point βmin of the blade angle β of the blade 122 is the value of the blade angle at a position existing in the latter half of the meridional length m of the blade 122. The latter half of the meridional length m is a portion of 0.5 m or more and 1.0 m or less. The minimum point βmin of the blade angle β may be at a position of 0.6 m or more and 1.0 m or less. The minimum point βmin of the blade angle β may be at a position of 0.75 m or more and 0.95 m or less. The minimum point βmin of the blade angle β may be, for example, 0.8 m or 0.9 m.

The blade angle β is expressed by the following equation (1):

$$tan β = rd θ / dm \qquad ( 1 )$$

As illustrated in FIG. 6, the notation of “r” is the length in the radial direction from the rotational axis C1 of the impellers 12A and 12B to the outer peripheral edge 123 of the blade 122. The notation of “θ” is the angle between the radial line segment connecting the outer peripheral edge 123a and the rotational axis C1 and the radial line segment connecting any point J on the outer peripheral edge 123 and the rotational axis C1 when viewed along the rotational axis C1. The notation of “m” is the meridional length.

### [Relationship Between Meridional Length and Static Pressure Coefficient and Static Pressure]

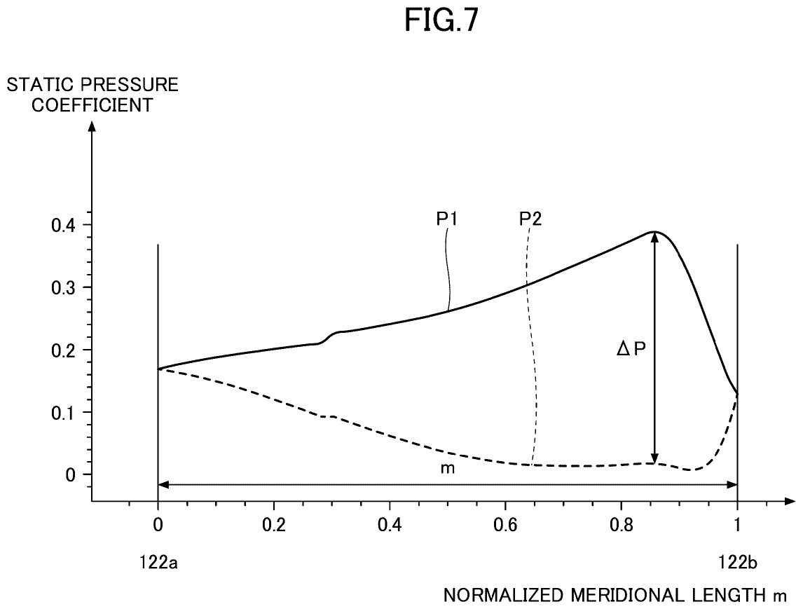

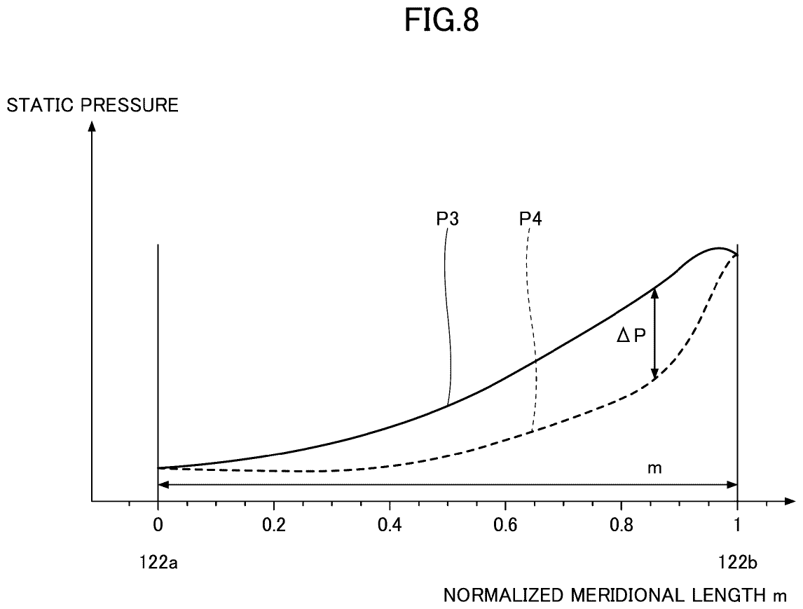

FIG. 7 is a graph illustrating the relationship between meridional length and static pressure coefficient. In FIG. 7, the normalized meridional length m is indicated on the horizontal axis, and the static pressure coefficient is indicated on the vertical axis. FIG. 7 illustrates the static pressure coefficient P1 on the positive pressure surface of the blade 122 and the static pressure coefficient P2 on the negative pressure surface of the blade 122. FIG. 8 is a graph illustrating the static pressure distribution, which is the relationship between meridional length and static pressure. In FIG. 8, the normalized meridional length m is indicated on the horizontal axis, and the static pressure is indicated on the vertical axis. FIG. 8 illustrates the static pressure P3 on the positive pressure surface of the blade 122 and the static pressure P4 on the negative pressure surface of the blade 122.

As illustrated in FIG. 7, for impellers 12A and 12B, ΔP1 (=P1−P2) is maximum when the value on the horizontal axis is approximately 0.85. As illustrated in FIG. 8, for the impellers 12A and 12B, ΔP2 (=P3−P4) is maximum when the value on the horizontal axis is approximately 0.85. Because ΔP1 and ΔP2 are small in the portion where the blade tip gap is large (the value on the horizontal axis is approximately 0), and ΔP1 and ΔP2 are large in the portion where the blade tip gap is small (the value on the horizontal axis is approximately 0.85), the blade tip leakage loss can be reduced.

### [Span Direction S]

Next, the span direction S will be described. FIG. 10 is a diagram in which shapes of the blade shape being rotated and projected around the rotational axis C1 are superimposed, in a cross section along the rotational axis C1. The span direction S is the direction orthogonal to the direction along the meridional length m, and is the direction along the blade 122. The “span length s” is the length from the outer peripheral surface 124 of the hub 121 to the outer peripheral edge 123 of the blade 122 in the span direction S. In the span direction S, the position where the span length s is 0 is the position on the outer peripheral surface 124 of the hub 121. In the span direction S, the position where the span length s is 1 is the position on the outer peripheral edge 123. In the span direction S, the position where the span length s is 0.5 s is the intermediate position between the outer peripheral surface 124 and the outer peripheral edge 123 of the hub 121. The position where the span length s exceeds 0.5 s is the position closer to the outer peripheral edge 123 than the position of 0.5 s.

### [Relationship Between the Span Length s and the Minimum Point of the Blade Angle]

As described above, the minimum point βmin of the blade angle β of the blade 122 exists in the latter half of the meridional length m of the blade 122. The minimum point βmin of the blade angle β exists at a position of 0.5 s or more with respect to the span length s. The minimum point βmin of the blade angle β may exist at a position of 0.9 s or more with respect to the span length s.

### [Operation of Centrifugal Compressor]

Referring again to FIG. 1, the operation of the centrifugal compressor 10 will be described. When the centrifugal compressor 10 is operated, the motor 50 is energized. Power is supplied to the motor 50, and the drive shaft 13 is driven to rotate. As the drive shaft 13 rotates, the impellers 12A and 12B rotate.

As the impeller 12A rotates, the refrigerant gas flows into the compression chamber 11a from the pipe L11. The refrigerant gas in the compression chamber 11a is compressed and boosted by the rotation of the impeller 12A. The refrigerant gas flowing into the compression chamber 11a is compressed to an intermediate pressure, for example. The refrigerant gas compressed to an intermediate pressure passes through the pipe L11B and is supplied to the impeller 12B.

The refrigerant gas in the pipe L11B is sucked into the compression chamber 11b with the rotation of the impeller 12B. The refrigerant gas in the compression chamber 11b is compressed and boosted by the rotation of the impeller 12B. The compressed refrigerant gas is discharged into the pipe L12. The refrigerant gas discharged from the centrifugal compressor 10 flows into the pipe L12 and flows into the condenser 20.

### [Effect of the Centrifugal Compressor in Embodiment]

The centrifugal compressor 10 includes, as illustrated in FIG. 3, open-type impellers 12A and 12B having a hub 121 and a blade 122 provided on the outer periphery of the hub 121, a drive shaft 13 connected to the impellers 12A and 12B as illustrated in FIG. 1, bearings 14A and 14B supporting the drive shaft 13, and a casing 11 covering the impellers 12A and 12B, wherein the movable range of the drive shaft 13 in the radial direction with respect to the bearings 14A and 14B is larger than the movable range of the drive shaft 13 with respect to the bearings 14A, 14B, and as illustrated in FIG. 4, the blade tip gap t1 (first gap) between the gas inlet side outer peripheral edge 123a of the blade 122 and the inner wall 15 of the casing 11 is larger than the blade tip gap t2 (second gap) between the gas outlet side outer peripheral edge 123b of the blade 122 and the inner wall 15 of the casing 11.

In the centrifugal compressor 10 of the present embodiment, the blade tip gap t2 between the gas outlet side outer peripheral edge 123b of the blade 122 and the inner wall 15 of the casing 11 is narrower than the blade tip gap t1 between the gas inlet side outer peripheral edge 123a of the blade 122 and the inner wall 15 of the casing 11. In the centrifugal compressor 10, in the gas flow direction, the blade tip gap t2, which is narrower than the blade tip gap t1 on the inlet side where the pressure is lower, is formed on the outlet side where the pressure is higher. Thus, on the high pressure outlet side, the leakage flow in the blade tip gap t2 between the outer peripheral edge 123b of the blade 122 and the inner wall 15 of the casing 11, can be reduced. In the centrifugal compressor 10, the reduction in the operating efficiency of the centrifugal compressor 10 can be prevented by reducing the blade tip leakage.

In the centrifugal compressor 10, the minimum point of the blade angle β of the blade 122 exists in the latter half of the meridional length m of the blade 122. In such a centrifugal compressor 10, a compressor having an impeller of the latter half load of a blade load distribution can be realized. In the centrifugal compressor 10, the contact between the outer peripheral edge 123a at the gas inlet side and the casing 11 can be prevented, and the occurrence of leakage flow in the blade tip gap can be reduced. In the centrifugal compressor 10, it is possible to avoid contact of the inlet blade tip and to reduce blade tip leakage loss.

In the centrifugal compressor 10, because the blade tip gap t1 on the gas inlet side is large, the separation of fluid on the negative pressure surface side can be prevented, and the occurrence of surging can be prevented. Further, because the impellers 12A and 12B are open impellers, they are easier to process than closed impellers.

In the centrifugal compressor 10, the blade load is high at the position where the blade angle β becomes the minimum point. In the part where the blade load is high, the pressure difference between the positive pressure surface and the negative pressure surface of the blade 122 increases. In the centrifugal compressor 10 of the present embodiment, the pressure difference between the positive pressure surface and the negative pressure surface of the blade 122 increases in the latter half part of the blade 122. The positive pressure surface is the surface with higher pressure among the surfaces facing the blade 122 in the thickness direction, and the negative pressure surface is the surface with lower pressure.

In the centrifugal compressor 10, the minimum point of blade angle β exists at a position of 0.6 m or more and 1.0 m or less with respect to meridional length m.

In the centrifugal compressor 10, when the direction along the blade 122 in the direction perpendicular to the meridional length m is defined as the span direction S, and the length from the outer peripheral surface 124 of the hub 121 to the outer peripheral edge 123 of the blade 122 in the span direction S is defined as the span length s, the minimum point of blade angle β exists at a position of 0.5 s or more with respect to the span length s in the latter half of the blade 122. According to the centrifugal compressor 10 having this configuration, the position where the pressure difference between the positive pressure surface and the negative pressure surface of the blade 122 increases exists at a position of 0.5 s or more of the span length with respect to the span direction S. In such a centrifugal compressor 10, the leakage flow in the gap between the tip of the blade 122 and the casing can be reduced. As a result, the reduction in the operating efficiency of the centrifugal compressor 10 can be prevented.

Further, in the centrifugal compressor 10, at a position of 0.9 s or more with respect to the span length s, the minimum point of the blade angle β may exist at the latter half of the blade 122.

In the centrifugal compressor 10, the bearings 14A, 14B, and 14C may be air bearings. In the centrifugal compressor 10, the bearings 14A, 14B, and 14C may be foil bearings. In the centrifugal compressor 10, the bearings 14A and 14B may be active magnetic bearings. The centrifugal compressor 10 having such bearings 14A, 14B, and 14C can support the drive shaft 13 rotating at high speed. The bearings 14A and 14B can reduce the maintenance of the bearings 14A, 14B, and 14C.

In the centrifugal compressor 10, the bearings 14A, 14B, and 14C which are active magnetic bearings can control the position of the drive shaft 13 so that the distance to the touchdown in the radial direction of the drive shaft 13 is greater than the distance to the touchdown in the axial direction of the drive shaft 13.

In the centrifugal compressor 10, the rotational speed of the impellers 12A and 12B may be 30,000 rpm or more. The centrifugal compressor 10 can be used as a compressor equipped with a high-head impeller requiring high-speed rotation. In the centrifugal compressor 10, the rotational speed of the impellers 12A and 12B may be less than 30,000 rpm.

Such a centrifugal compressor 10 can tolerate large unsteady vibrations compared to the that of the conventional technology. The centrifugal compressor 10 can tolerate unsteady vibrations of the impellers 12A and 12B. The centrifugal compressor 10 can be used, for example, as an air-cooled high-pressure turbo compressor. The centrifugal compressor 10 can be used as a small-capacity compressor. Conventional centrifugal compressors are often used for high-capacity, low-differential compressors, but this type of the centrifugal compressor 10 can be used as a small-capacity, high-differential compressor.

The above-described preferred embodiments of the present invention have been described in detail. However, the present invention is not limited to the above-described embodiments. The above-described embodiments can be modified and replaced without departing from the scope of the present invention. Also, the features described separately can be combined as long as there is no technical conflict.

Although the above embodiment illustrates the refrigerator 100 with the centrifugal compressor 10, the centrifugal compressor 10 can be applied to applications other than the refrigerator 100. The internal fluid of the centrifugal compressor 10 is not limited to a refrigerant.

One aspect of the present invention may be as follows.

<1>

A centrifugal compressor including:
an open-type impeller having a hub and blades provided on a periphery of the hub;
a rotating shaft connected to the impeller;
a bearing for supporting the rotating shaft; and
a casing for covering the impeller, wherein
a movable range in a radial direction of the rotating shaft with respect to the bearing is larger than a movable range in an axial direction of the rotating shaft with respect to the bearing, and
a first gap between an outer peripheral edge of the blade on a gas inlet side and an inner wall of the casing is larger than a second gap between an outer peripheral edge of the blade on a gas outlet side and the inner wall of the casing.
   <2>

The centrifugal compressor according to <1>, wherein a minimum point of a blade angle of the blade is located in a latter half of the blade.

<3>

The centrifugal compressor according to <2>, wherein the minimum point of the blade angle is located at a position of 0.6 m or more and 1.0 m or less with respect to a meridional length m.

30<4>

The centrifugal compressor according to <2> or <3>, wherein
a direction that is along the blade and that is in a direction perpendicular to a direction of the meridional length m, is given as a span direction; and
when a length from an outer peripheral surface of the hub to an outer peripheral edge of the blade in the span direction is given as a span length s,
at a position of 0.5 s or more with respect to the span length s, the minimum point of the blade angle is located at the latter half of the blade.
   <5>

The centrifugal compressor according to <4>, wherein at a position of 0.9 s or more with respect to the span length s, the minimum point of the blade angle is located at the latter half of the blade.

<6>

The centrifugal compressor according to any one of <1> to <5>, wherein the bearing is an air bearing, a foil bearing, an active magnetic bearing, a rolling bearing, or a sliding bearing.

<7>

The centrifugal compressor according to <6>, wherein
the bearing is the active magnetic bearing, and
the active magnetic bearing controls a position of the rotating shaft such that a distance to a touchdown in the radial direction of the rotating shaft is greater than a distance to a touchdown in the axial direction of the rotating shaft.
   <8>

The centrifugal compressor according to any one of <1> to <7>, wherein a distance of the first gap is twice or more than a distance of the second gap.

<9>

The centrifugal compressor according to any one of <1> to <8>, wherein a rotational speed of the impeller is 30,000 rpm or more.

The present international application is based upon and claims priority to Japanese patent application no. 2023-058713 filed on Mar. 31, 2023, the entire contents of which are incorporated herein by reference.

### REFERENCE SIGNS LIST

10 centrifugal compressor
12A and 12B impeller
13 drive shaft (rotating shaft)
14A, 14B bearing (air bearing, foil bearing, active magnetic bearing)
15 inner wall
121 hub
122 blade
t1 blade tip gap (first gap)
t2 blade tip gap (second gap)

1. A centrifugal compressor comprising:
an open-type impeller having a hub and blades provided on a periphery of the hub;
a rotating shaft connected to the impeller;
a bearing for supporting the rotating shaft; and
a casing for covering the impeller, wherein a movable range in a radial direction of the rotating shaft with respect to the bearing is larger than a movable range in an axial direction of the rotating shaft with respect to the bearing, and
a first gap between an outer peripheral edge of the blade on a gas inlet side and an inner wall of the casing is larger than a second gap between an outer peripheral edge of the blade on a gas outlet side and the inner wall of the casing.

2. The centrifugal compressor according to claim 1, wherein a minimum point of a blade angle of the blade is located in a latter half of the blade.

3. The centrifugal compressor according to claim 2, wherein the minimum point of the blade angle is located at a position of 0.6 m or more and 1.0 m or less with respect to a meridional length m.

4. The centrifugal compressor according to claim 2, wherein
a direction that is along the blade and that is in a direction perpendicular to a direction of the meridional length m, is given as a span direction; and
when a length from an outer peripheral surface of the hub to an outer peripheral edge of the blade in the span direction is given as a span length s,
at a position of 0.5 s or more with respect to the span length s, the minimum point of the blade angle is located at the latter half of the blade.

5. The centrifugal compressor according to claim 4, wherein at a position of 0.9 s or more with respect to the span length s, the minimum point of the blade angle is located at the latter half of the blade.

6. The centrifugal compressor according to claim 1, wherein the bearing is an air bearing, a foil bearing, an active magnetic bearing, a rolling bearing, or a sliding bearing.

7. The centrifugal compressor according to claim 6, wherein
the bearing is the active magnetic bearing, and
the active magnetic bearing controls a position of the rotating shaft such that a distance to a touchdown in the radial direction of the rotating shaft is greater than a distance to a touchdown in the axial direction of the rotating shaft.

8. The centrifugal compressor according to claim 1, wherein a distance of the first gap is twice or more than a distance of the second gap.

9. The centrifugal compressor according to claim 1, wherein a rotational speed of the impeller is 30,000 rpm or more.
